(19) United States
(12) Patent Application Publication
(10) Pub. No.: US 2026/0192624 A1
(43) Pub. Date: Jul. 9, 2026

(54) VEHICLE SUSPENSION STRUCTURE

(71) Applicant: Honda Motor Co., Ltd., Tokyo (JP)

(72) Inventors: Takumi ISHIKAWA, Tokyo (JP); Masato YOSHIMURA, Tokyo (JP)

(73) Assignee: Honda Motor Co., Ltd., Tokyo (JP)

(21) Appl. No.: 19/378,368

(22) Filed: Nov. 4, 2025

(30) Foreign Application Priority Data
Jan. 3, 2025 (CN) 202510011265.X

(51) Int. Cl. B60G 13/00

(52) U.S. Cl. CPC B60G 13/005; B60G 2204/43

(57) ABSTRACT

A vehicle suspension structure includes: a damper, mounted on a vehicle body; and a clamping component, fastened to the damper, and fastened to a suspension arm or a steering knuckle. The clamping component has a clamping portion fastened to the damper. The clamping portion is provided with a first thin-walled portion at an axial center. The first thin-walled portion has a thickness in a radial direction thinner than a thickness of an axial end portion of the clamping portion in the radial direction.

### CROSS-REFERENCE TO RELATED APPLICATION

This application claims the priority benefit of China application serial no. 202510011265.X, filed on January 3, 2025. The entirety of the above-mentioned patent application is hereby incorporated by reference herein and made a part of this specification.

### BACKGROUND

### Technical Field

The disclosure relates to a vehicle structure, and more particularly to a vehicle suspension structure.

### Description of Related Art

In recent years, efforts to provide access to sustainable transportation systems that also take into account vulnerable persons such as the elderly, the disabled, and children among traffic participants have been active. In order to achieve the stated purpose, research and development efforts are made to further improve the safety and convenience of transportation through safety-related development. However, the vehicle suspension structure is a subject of concern in technologies related to safety.

For example, in the prior art (e.g., Japanese Patent Application Laid-Open No. 2003-104020), a vehicle suspension structure has a clamping component (also referred to as a fork) formed by a clamping portion and a pair of leg portions. The clamping component (fork) is used for supporting a damper and is fastened to a lower arm of a suspension arm. By fastening the clamping component at the open groove by means of a bolt or a fastener, the diameter of the clamping component is reduced, thereby generating fastening stress and enabling the clamping component to be fastened to the damper. However, it is difficult for the fastening stress generated by the clamping component to be generated uniformly in both the circumferential direction and the axial direction. Thus, it is necessary to improve the vehicle suspension structure.

The disclosure aims to achieve uniform fastening stress at least in the axial direction in a vehicle suspension structure in order to solve the above-mentioned issue. Moreover, the traffic safety is further improved so that it is beneficial to develop sustainable transportation systems.

### SUMMARY

The disclosure provides a vehicle suspension structure that may generate uniform fastening stress at least in the axial direction and has a favorable fastening effect.

The disclosure provides a vehicle suspension structure, including: a damper, mounted on a vehicle body; and a clamping component, fastened to the damper, and fastened to a suspension arm or a steering knuckle. The clamping component has a clamping portion fastened to the damper. The clamping portion is provided with a first thin-walled portion at an axial center. The first thin-walled portion has a thickness in a radial direction thinner than a thickness of an axial end portion of the clamping portion in the radial direction.

Based on the above, in the vehicle suspension structure of the disclosure, the clamping component (also referred to as a fork) has a clamping portion fastened to the damper. The clamping portion is provided with the first thin-walled portion at the axial center, and the first thin-walled portion has a thickness in the radial direction thinner than a thickness of the axial end portion of the clamping portion in the radial direction. Thus, the setting of the first thin-walled portion serves to enable the clamping portion to have the thickness at the axial center thinner than the thickness at the axial end portion, so that the clamping portion may still generate uniform fastening stress in the axial direction even when only one side of the clamping portion is provided with a fastener that reduces the diameter of the clamping portion. Accordingly, the vehicle suspension structure of the disclosure may generate uniform fastening stress at least in the axial direction and has a favorable fastening effect.

In order to make the above-mentioned features and advantages of the disclosure comprehensible, embodiments accompanied with drawings are described in detail below.

### BRIEF DESCRIPTION OF THE DRAWINGS

FIG. 1 is a schematic perspective diagram of a vehicle suspension structure according to an embodiment of the disclosure.

FIG. 2 is a schematic perspective diagram of a clamping component used in the vehicle suspension structure depicted in FIG. 1.

FIG. 3 is a schematic cross-sectional diagram in a radial direction of a portion of the clamping portion of the clamping component depicted in FIG. 2 without a protruding portion.

FIG. 4 is a schematic cross-sectional diagram in a radial direction of a portion of the clamping portion of the clamping component depicted in FIG. 2 with a protruding portion.

### DESCRIPTION OF THE EMBODIMENTS

In an embodiment of the disclosure, one side of the clamping portion is provided with an open groove, and the first thin-walled portion is configured at least at a position of the clamping portion symmetrical to the open groove.

In an embodiment of the disclosure, the clamping component further has a leg portion extending outward from the clamping portion and connected to the suspension arm. The leg portion has a second thin-walled portion. The second thin-walled portion has a thickness in a circumferential direction thinner than a thickness of other portions of the leg portion in the circumferential direction.

In an embodiment of the disclosure, the second thin-walled portion is smoothly connected to the first thin-walled portion.

In an embodiment of the disclosure, the clamping component further has a stabilizer link fastening portion disposed in the vicinity of a connection position between the clamping portion and the leg portion.

In an embodiment of the disclosure, the clamping component further has a bracket fastening portion disposed in the vicinity of a connection position between the clamping portion and the leg portion.

In an embodiment of the disclosure, the clamping portion has a protruding portion disposed on the first thin-walled portion. The protruding portion has a thickness in the radial direction thicker than the thickness of the first thin-walled portion in the radial direction, and thinner than the thickness of the axial end portion of the clamping portion in the radial direction.

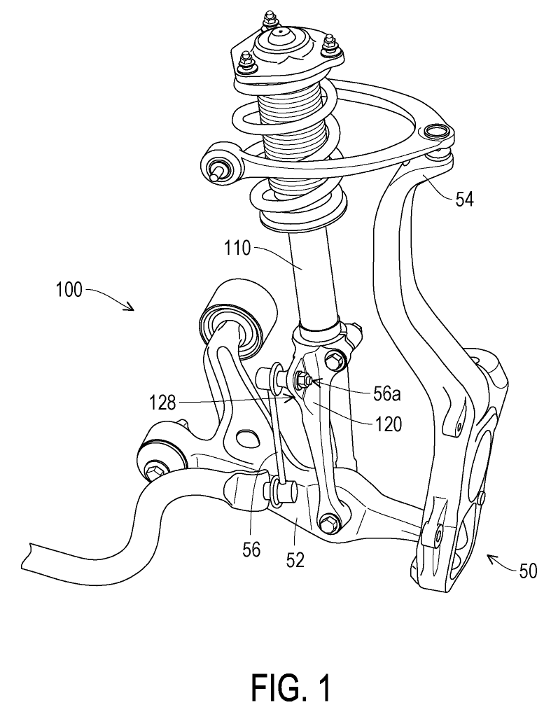

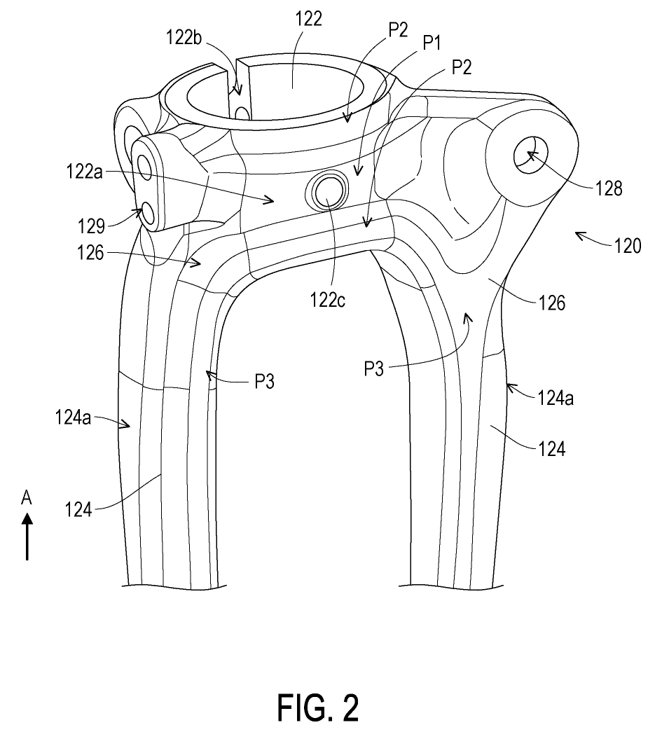

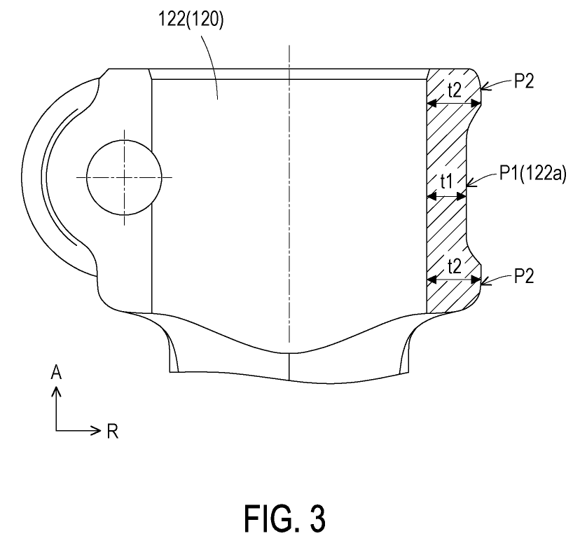

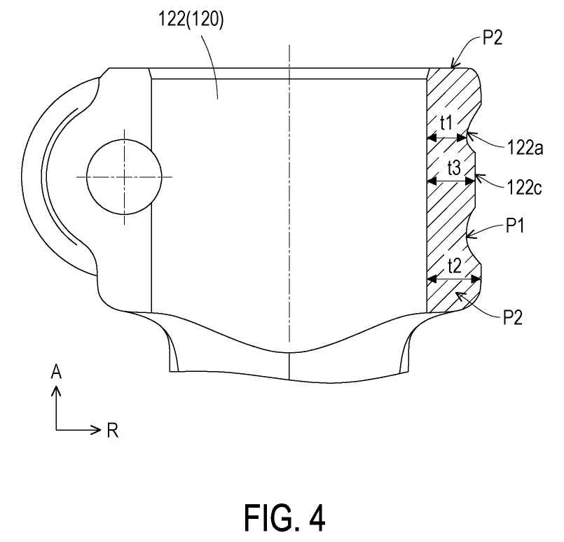

Reference is now made in detail to exemplary embodiments of the disclosure, and examples of the exemplary embodiments are described in the accompanying drawings. FIG. 1 is a schematic perspective diagram of a vehicle suspension structure according to an embodiment of the disclosure. FIG. 2 is a schematic perspective diagram of a clamping component used in the vehicle suspension structure depicted in FIG. 1. FIG. 3 is a schematic cross-sectional diagram in a radial direction of a portion of the clamping portion of the clamping component depicted in FIG. 2 without a protruding portion. FIG. 4 is a schematic cross-sectional diagram in a radial direction of a portion of the clamping portion of the clamping component depicted in FIG. 2 with a protruding portion. The specific structures of the vehicle suspension structure 100 of the embodiment will be illustrated below with reference to FIG. 1 to FIG. 4, but these are only some examples of the disclosure, and the disclosure is not limited thereto, and may be adjusted according to requirements.

Referring to FIG. 1 to FIG. 3, in the embodiment, the vehicle suspension structure 100 includes a damper 110 and a clamping component 120. The damper 110 is mounted on a vehicle body 50. The clamping component (also referred to as a fork) 120 is fastened to the damper 110, and is fastened to a suspension arm 52 or a steering knuckle 54. The clamping component 120 has a clamping portion 122 fastened to the damper 110. As shown in FIG. 2, the clamping portion 122 is provided with a first thin-walled portion 122a at the axial center (i.e., at a center portion P1 in an axial direction A). As shown in FIG. 3A, a thickness t1 of the first thin-walled portion 122a in a radial direction R is thinner than a thickness t2 of the axial end portion (i.e., an end portion P2 on the axial direction A) of the clamping portion 122 in the radial direction R.

Specifically, in the embodiment, as shown in FIG. 1, the vehicle body 50 is provided with structures such as the suspension arm 52 and the steering knuckle 54. The damper 110 is, for example, mounted on the vehicle body 50, and is adapted to move along the axial direction A to provide a damping effect in the axial direction A. Furthermore, as shown in FIG. 2 and FIG. 3, the clamping portion 122 is, for example, configured as a substantially annular structure, and is disposed on the outer periphery of the damper 110 along the axial direction A (i.e., surrounding the damper 110). One side of the clamping portion 122 is provided with an open groove 122b (e.g., a narrow groove extending along the axial direction A). By passing a fastener (not shown, such as a bolt) through the portion of the clamping portion 122 where the open groove 122b is provided, the spacing of the open groove 122b may be narrowed, such that the diameter of the clamping portion 122 may be reduced, and the clamping component 120 may be fastened to the damper 110.

Furthermore, in the embodiment, as shown in FIG. 2 and FIG. 3, the clamping portion 122 configured as a substantially annular structure has a center portion P1 and two opposite end portions P2 in the axial direction A. The two opposite end portions P2 of the clamping portion 122 have equal thickness in the radial direction R (e.g., thickness t2), but the thickness of the center portion P1 of the clamping portion 122 in the radial direction R (e.g., thickness t1) is smaller compared to the thickness of the end portions P2 in the radial direction R (e.g., thickness t2), thereby forming the first thin-walled portion 122a with reduced thickness at the axial center of the clamping portion 122 (i.e., at the center portion P1 in the axial direction A). As an example, the first thin-walled portion 122a is configured as an annular groove extending along the circumferential direction at the axial center of the clamping portion 122 (i.e., the center portion P1). Accordingly, the clamping portion 122 may have a substantially annular structure with reduced thickness at the axial center.

Through the above configuration, in the vehicle suspension structure 100 of the embodiment, as shown in FIG. 1 to FIG. 3, the clamping component (also referred to as a fork) 120 has a clamping portion 122 fastened to the damper 110. The clamping portion 122 is provided with a first thin-walled portion 122a at the axial center. The thickness t1 of the first thin-walled portion 122a in the radial direction R is thinner than the thickness t2 of the axial end portion of the clamping portion 122 in the radial direction R. In this way, when the clamping portion 122 provided with the first thin-walled portion 122a has the thickness t1 at the axial center thinner than the thickness t2 at the axial end portion, it enables the clamping portion 122 to still generate uniform fastening stress in the axial direction A even when only one side of the clamping portion is provided with a fastener that reduces the diameter of the clamping portion 122. Accordingly, the vehicle suspension structure 100 may generate uniform fastening stress at least in the axial direction A and have a favorable fastening effect.

Furthermore, in the embodiment, as shown in FIG. 2 and FIG. 3, the first thin-walled portion 122a is configured at least at a position of the clamping portion 122 symmetrical to the open groove 122b. That is, the first thin-walled portion 122a (e.g., an annular groove extending along the circumferential direction at the axial center of the clamping portion 122) is disposed opposite to the open groove 122b that is fastenable by a fastener, and is symmetrical to the open groove 122b in the axial direction A, rather than being arranged around the entire circumferential direction of the clamping portion 122 at the axial center of the clamping portion 122, but the disclosure is not limited thereto. In this way, the clamping portion 122 may not only generate uniform fastening stress in the axial direction A by reducing the thickness of the first thin-walled portion 122a in the radial direction R, but also generate uniform fastening stress in the circumferential direction by setting the first thin-walled portion 122a at a position symmetrical to the open groove 122. Moreover, by setting the first thin-walled portion 122a at a position where the fastening force is low relative to the open groove 122b (i.e., at a position symmetrical to the open groove 122b), the fastening effect of the clamping portion 122 may be further improved. However, the disclosure does not limit the specific structure and setting position of the first thin-walled portion 122a, which may be adjusted according to requirements.

Furthermore, in the embodiment, as shown in FIG. 1 and FIG. 2, the clamping component 120 further has a leg portion 124 extending outward from the clamping portion 122 and connected to the suspension arm 52. The leg portion 124 has a second thin-walled portion 124a. The second thin-walled portion 124a has a thickness in the circumferential direction thinner than a thickness of other portions of the leg portion 124 in the circumferential direction. As an example, a pair of leg portions 124 extend downward from the bottom surface side of the clamping portion 122 and are symmetrically disposed in the circumferential direction. In this way, the pair of leg portions 124 may be symmetrically connected with the suspension arm 52 in the circumferential direction, and the fastening stress generated by the reduced diameter of the clamping portion 122 may be uniformly transmitted between the pair of leg portions 124. Preferably, the first thin-walled portion 122a and the open groove 122b are respectively located between the pair of leg portions 124 in the circumferential direction and are symmetrical to each other, and the first thin-walled portion 122a (e.g., an annular groove) extends between the pair of leg portions 124 and extends to a connection position 126 between the clamping portion 122 and the pair of leg portions 124. Here, each pair of leg portion 124 is provided with the second thin-walled portion 124a. The second thin-walled portion 124a extends from the end portion of the leg portion 124 close to the clamping portion 122 (i.e., the connection position 126) to the end portion away from the clamping portion 122. That is, the second thin-walled portion 124a is configured as a strip-shaped groove extending in the leg portion 124 such that the second thin-walled portion 124a may achieve weight reduction while maintaining the rigidity of the clamping component 120. However, the disclosure does not limit the specific structure and setting position of the leg portion 124 and the second thin-walled portion 124a, which may be adjusted according to requirements.

Additionally, in the embodiment, as shown in FIG. 2, the second thin-walled portion 124a and the first thin-walled portion 122a are smoothly connected. Specifically, the first thin-walled portion 122a of the clamping portion 122 (formed by an annular groove with small thickness) and the second thin-walled portion 124a of the leg portion 124 (formed by a strip-shaped groove with small thickness) respectively extend to the connection position 126 between the clamping portion 122 and the leg portion 124 to connect with each other. Preferably, the first thin-walled portion 122a and the second thin-walled portion 124a communicate with each other and are configured as the same groove structure with continuously extending inner surface. In this way, the smooth connection between the first thin-walled portion 122a and the second thin-walled portion 124a serves to reduce the thickness of the outer end surface of the axial center of the clamping portion 122 (i.e., a portion of the connection position 126), and may prevent fastening stress from concentrating at the connection position of the leg portion 124 and the clamping portion 122, thereby achieving a uniform fastening effect without damaging the connection position. Preferably, the end portions P2 of the clamping portion 122 and other portions of the leg portion 124 (e.g., the front side end portion P3) are also smoothly connected, so that the clamping component 120 as a whole may avoid damage caused by fastening stress concentration. However, the disclosure does not limit the setting position of the first thin-walled portion 122a and the second thin-walled portion 124a, which may be adjusted according to requirements.

Furthermore, in the embodiment, as shown in FIG. 2, the clamping component 120 further has a stabilizer link fastening portion 128 disposed in the vicinity of the connection position 126 between the clamping portion 122 and the leg portion 124. Moreover, the clamping component 120 further has a bracket fastening portion 129 disposed in the vicinity of the connection position 126 between the clamping portion 122 and the leg portion 124. As an example, the vehicle body 50 further comprises a stabilizer link 56 and a bracket (not shown). The clamping component 120 is fastened to the stabilizer link 56 by a stabilizer link fastener 56a (e.g., bolt, etc.) passing through the stabilizer link fastening portion 128. Moreover, using a fastener (not shown, such as a bolt), a bracket (not shown) for holding brake hoses, wires, hydraulic pipelines, etc. is fixed to the bracket fastening portion 129. Preferably, the stabilizer link fastening portion 128 and the bracket fastening portion 129 are respectively disposed in the vicinity of the pair of leg portions 124, and are disposed opposite to each other in the circumferential direction. In this way, by configuring the stabilizer link fastening portion 128 and the bracket fastening portion 129 in the vicinity of the leg portions 124, it may prevent the uniform fastening effect generated by the first thin-walled portion 122a of the clamping portion 122 from weakening when the clamping component 120 is fastened to the stabilizer link 56 and the bracket. However, the disclosure does not limit the specific structure, setting position, or setting of the stabilizer link fastening portion 128 and the bracket fastening portion 129, which may be adjusted according to requirements.

Additionally, in the embodiment, as shown in FIG. 2 and FIG. 4, the clamping portion 122 has a protruding portion 122c disposed on the first thin-walled portion 122a. A thickness t3 of the protruding portion 122c in the radial direction R is thicker than the thickness t1 of the first thin-walled portion 122a in the radial direction R, and is thinner than the thickness t2 of the axial end portion (i.e., end portion P2) of the clamping portion 122 in the radial direction R. As an example, the protruding portion 122c protrudes outward from the recessed surface of the first thin-walled portion 122a along the radial direction R, so that the thickness t3 of the protruding portion 122c is greater than the thickness t2 of the first thin-walled portion 122a. In contrast, the protruding portion amount of the protruding portion 122c protruding outward from the recessed surface of the first thin-walled portion 122a along the radial direction R does not exceed the outer peripheral surface of the end portion P2 of the clamping portion 122, so that the thickness t3 of the protruding portion 122c is smaller than the thickness t2 of the end portion P2 of the clamping portion 122. In this way, when the clamping component 120 is removed from a mold (not shown) during the manufacturing process, an ejector pin (not shown) may abut against the protruding portion 122c, so that the clamping component 120 may be demolded from the end portion of the clamping portion 122 with higher quality and greater reliability, thereby preventing the uniform fastening effect generated by the first thin-walled portion 122a of the clamping portion 122 from weakening and improving the production technology. However, the disclosure does not limit the specific structure, setting position, or setting of the protruding portion 122c, which may be adjusted according to requirements.

In summary, in the vehicle suspension structure of the disclosure, the clamping component (also referred to as a fork) has a clamping portion fastened to the damper, the clamping portion is provided with a first thin-walled portion at the axial center, and the thickness of the first thin-walled portion in the radial direction is thinner than the thickness of the axial end portion of the clamping portion in the radial direction. Thus, the setting of the first thin-walled portion serves to enable the clamping portion to have the thickness at the axial center thinner than the thickness at the axial end portion, so that the clamping portion may still generate uniform fastening stress in the axial direction even when only one side of the clamping portion is provided with a fastener that reduces the diameter of the clamping portion. Preferably, the first thin-walled portion is configured at least at a position symmetrical to the open groove disposed on one side of the clamping portion. That is, the first thin-walled portion is disposed opposite to the open groove that is fastenable by a fastener, so that the clamping portion may generate uniform fastening stress in the circumferential direction. Accordingly, the vehicle suspension structure of the disclosure may generate uniform fastening stress at least in the axial direction (and further in the circumferential direction) and has a favorable fastening effect.

Finally, it should be noted that the foregoing embodiments are only used to illustrate the technical solutions of the disclosure, but not to limit the disclosure; although the disclosure has been described in detail with reference to the foregoing embodiments, persons of ordinary skill in the art should understand that the technical solutions described in the foregoing embodiments can still be modified, or parts or all of the technical features thereof can be equivalently replaced; however, these modifications or substitutions do not deviate the essence of the corresponding technical solutions from the scope of the technical solutions of the embodiments of the disclosure.

What is claimed is:

1. A vehicle suspension structure, comprising:
a damper, mounted on a vehicle body; and
a clamping component, fastened to the damper, and fastened to a suspension arm or a steering knuckle, wherein
the clamping component has a clamping portion fastened to the damper,
the clamping portion is provided with a first thin-walled portion at an axial center, and
the first thin-walled portion has a thickness in a radial direction thinner than a thickness of an axial end portion of the clamping portion in the radial direction.

2. The vehicle suspension structure according to claim 1, wherein
one side of the clamping portion is provided with an open groove, and
the first thin-walled portion is configured at least at a position of the clamping portion symmetrical to the open groove.

3. The vehicle suspension structure according to claim 1, wherein
the clamping component further has a leg portion extending outward from the clamping portion and connected to the suspension arm,
the leg portion has a second thin-walled portion, and
the second thin-walled portion has a thickness in a circumferential direction thinner than a thickness of other portions of the leg portion in the circumferential direction.

4. The vehicle suspension structure according to claim 2, wherein
the clamping component further has a leg portion extending outward from the clamping portion and connected to the suspension arm,
the leg portion has a second thin-walled portion, and
the second thin-walled portion has a thickness in a circumferential direction thinner than a thickness of other portions of the leg portion in the circumferential direction.

5. The vehicle suspension structure according to claim 3, wherein
the second thin-walled portion is smoothly connected to the first thin-walled portion.

6. The vehicle suspension structure according to claim 3, wherein
the clamping component further has a stabilizer link fastening portion disposed in a vicinity of a connection position between the clamping portion and the leg portion.

7. The vehicle suspension structure according to claim 3, wherein
the clamping component further has a bracket fastening portion disposed in a vicinity of a connection position between the clamping portion and the leg portion.

8. The vehicle suspension structure according to claim 1, wherein
the clamping portion has a protruding portion disposed on the first thin-walled portion,
the protruding portion has a thickness in the radial direction thicker than the thickness of the first thin-walled portion in the radial direction, and thinner than the thickness of the axial end portion of the clamping portion in the radial direction.

9. The vehicle suspension structure according to claim 2, wherein
the clamping portion has a protruding portion disposed on the first thin-walled portion,
the protruding portion has a thickness in the radial direction thicker than the thickness of the first thin-walled portion in the radial direction, and thinner than the thickness of the axial end portion of the clamping portion in the radial direction.
